(19) United States
(12) Patent Application Publication
(10) Pub. No.: US 2021/0211412 A1
(43) Pub. Date: Jul. 8, 2021

(54) VIRTUAL PRIVATE NETWORK ENVIRONMENT FOR APPLICATION UNIFICATION OVER A PUBLIC NETWORK

(71) Applicants: Andrew Robinson, Kaneohe, HI (US); Alexei Tumarkin, Los Altos Hills, CA (US)

(72) Inventors: Andrew Robinson, Kaneohe, HI (US); Alexei Tumarkin, Los Altos Hills, CA (US)

(21) Appl. No.: 17/210,451

(22) Filed: Mar. 23, 2021

Related U.S. Application Data
(63) Continuation-in-part of application No. PCT/US19/52791, filed on Sep. 24, 2019.
Application No. PCT/US19/52791 is a continuation of application No. PCT/US19/52793, filed on Sep. 24, 2019.
Application No. PCT/US19/52793 is a continuation-in-part of application No. PCT/US20/52420, filed on Sep. 24, 2020.
Application No. PCT/US20/52420 is a continuation-in-part of application No. 16/816,170, filed on Mar. 11, 2020, now abandoned.
(60) Provisional application No. 62/735,617, filed on Sep. 24, 2018.
(60) Provisional application No. 62/905,351, filed on Sep. 24, 2019.
(60) Provisional application No. 62/817,996, filed on Mar. 13, 2019.

(51) Int. Cl. H04L 29/06; H04L 29/08

(52) U.S. Cl. CPC H04L 63/0272; H04L 67/2838; H04L 67/2823; H04L 67/02

(57) ABSTRACT

Described is a content server for establishing a virtual private network environment for application unification over a public network for an enterprise having a plurality of enterprise-users, where the public network has one or more public network sites and applications.

### CROSS-REFERENCE TO RELATED APPLICATION AND CLAIM OF PRIORITY

The present application is a continuation of and claims priority to earlier filed PCT patent application No. PCT/US19/52793, filed on Sep. 24, 2019, and titled “Virtual Private Network Environment For Application Unification Over A Public Network,” which claims priority to an earlier filed U.S. provisional patent application No. 62/735,617, filed on Sep. 24, 2018, and titled “System and Method for Providing Application Unification For Web Sites and Internet Applications,” both of which are hereby incorporated by reference in their entirety.

The present application is a continuation-in-part of and claims priority to earlier filed PCT patent application No. PCT/US19/52791, filed on Sep. 24, 2019, and titled “Content Server For Providing Application Unification For Public Network Applications,” which claims priority to an earlier filed U.S. provisional patent application No. 62/735,617, filed on Sep. 24, 2018, and titled “System and Method for Providing Application Unification For Web Sites and Internet Applications,” both of which are hereby incorporated by reference in their entirety.

The present application is also continuation-in-part of and claims priority to earlier filed PCT patent application No PCT/US20/52420, filed on Sep. 24, 2020, and titled “Content Server For Mapping A Plurality of Third-Party Entities and Their Inter-dependencies For Information Content Accessed By A Computing Device Over A Network,” which claims priority to the earlier filed U.S., provisional patent application No. 62/905,351, filed on Sep. 24, 2019, and titled “Content Server For Mapping A Plurality of Third-Party Entities and Their Inter-dependencies For Information Content Accessed By A Computing Device Over A Network,” both of which are also hereby incorporated by reference in their entirety.

The present application is also continuation-in-part of and claims priority to earlier filed U.S. patent application Ser. No. 16/816,170, filed on Mar. 11, 2020, and titled “Content Server For Managing Media Data Between Publishers, Third-party Networks and a Computing Device,” which claims priority to U.S. provisional patent application No. 62/817,996, filed on Mar. 13, 2019, and titled “Content Server For Managing Media Data Between Publishers, Third-party Networks and a Computing Device,” both of which are also hereby incorporated by reference in their entirety.

### BACKGROUND

### 1. Field

The present disclosure is related to computing systems that communicate over a network, and more specifically, to computing systems that receive, modify, and transfer data over a network.

### 2. Related Art

Electronic commerce (“e-commerce”) has become a large portion of the world economy. With the increase in e-commerce, the associated hardware and software applications related to commercial use over the Internet have improved, increased, and diversified to the point of creating “Cloud” based systems on the Internet. These Cloud based systems have created “Cloud Computing” applications that are on-demand applications that allow individual end-users and/or businesses to access computer system resources, especially data storage and computer power, without the direct active management by the end-user or business. These improvements have resulted in enterprises moving to and utilizing cloud services and Software-as-a-Service (“SaaS”) applications instead of self-hosted ones, which creates a mishmash of heterogeneous data sources and transactions over which enterprises and their employees have no control. For example, if an enterprise portal includes “feeds” from multiple third-party entities acting as SaaS providers, then the transactions performed by employees on these SaaS providers cannot be visible in real time by the enterprise and are only auditable through special arrangements with such providers.

At present, more and more enterprises (i.e., businesses) are either outsourcing their existing self-hosted applications to cloud based services and/or SaaS applications or initiating establishing those applications with the cloud based services and/or SaaS applications instead of ever self-hosting. As such, enterprises are relying more and more on second-party and third-party entities are relying on both second-party and third-party entities to provide information technology (“IT”) services and key functions for the enterprise. Examples of these key functions may include, for example, file storage applications, network access storage (“NAS”), financial applications such as time keeping services, payroll, accounting, banking, tax preparation applications, employee health plan information, etc., customer information and contact lists, customer relationship management (“CRM”) services, supplier information, project management software applications, email, electronic calendars, content trackers, business intelligence applications, advertisement media and information, webpage hosting, etc. Moreover, local-users and remote-users (that are generally employees of the enterprise and are referred to enterprise-users) are being forced to access these key functions directly over the Internet without going through a local gatekeeper system at the enterprise. The reason for this is that many of these cloud based services and/or SaaS applications are accessed via website applications via the Internet that are independent of the enterprise and are accessed by enterprise-users utilizing Internet browsers (generally referred to as “web browsers” or simply “browsers”) that connect to and interact with websites run and managed by second-party and third-party entities (usually businesses) over the World Wide Web (generally referred to simply as “the Web”). These websites include website applications that display information on a webpage of the browser of a computing device of an enterprise-user that is connected to the website. The websites are text files that utilize hypertext markup language (“HTML”) or other similar markup language (for simplicity referred to herein as just “HTML”).

Typically, these websites often include content, such as images and inline frames (i.e., HTML documents embedded inside another HTML document of a website known as “iframes”), located on servers controlled by the second-party and/or third-party entities. A browser on a computing device of an enterprise-user loading an HTML webpage will contact these additional servers directly to satisfy external content dependencies within the webpage without going through a gatekeeper of the enterprise. As such, some of these website applications are run off-site by second-party and/or third-party entities that control and manage these website applications instead of the enterprise.

Unfortunately, these second-party and third-party entities have direct access to the enterprise-users and the associated data and may, in turn, share that information with or redirect those enterprise-users to other third-party entities. Consequently, as public networks, such as the Internet, expand and improve, the enterprise-users interact (often unknowingly) with an expanding universe of second-parties and third-parties entities. As such, the functionality offered by these website applications (that are run off-site from the enterprise by the cloud based services and/or SaaS applications) introduce visibility and unification concerns that cannot be addressed by existing systems and procedures. Specifically, these types of functionality have multiple security and privacy implications because they have direct access to the key functions of the enterprise including sensitive information of the enterprise and information of the customers and suppliers of the enterprise. This may lead to, for example, data exposure, malware distribution and insertion, information leakage, and regulatory non-compliance. Security and privacy issues arise as a result of the enterprise not being able to control the third-party entity leading to a customer of the enterprise and/or the enterprise itself being susceptible to any privacy invading actions and/or security flaws at the third-party entity or malevolent acts performed by the third-party entity. Furthermore, by having direct access to enterprise-users, they have access to information from the enterprise-user that includes context related to the browsing history of an enterprise-user and potentially access to the computing device of the enterprise-user through malicious software that may be seeded on to the computing device of the enterprise-user. Moreover, as far as customers of the enterprise that may access a website hosted by the enterprise that redirects the customers to a third-party entity for desired information or functionality, that the third-party entity will have access to information from the customer that includes context related to the browsing history of a customer and potentially access to the computing device of the customer through malicious software that may be seeded on to the computing device of the customer and both the customer lacks transparency of the situation because an address bar of a browser of the customer only displays the address of the website visited directly (i.e., the website of the enterprise). As such, with this functionality comes the possibility of compromising the privacy of an customer and/or enterprise-user which may lead to liability (for example a lawsuit and/or a general data protection regulation (“GDPR”) violation in Europe) on the part of the enterprise even though the privacy of the customer and/or enterprise-user was compromised by a third-party entity that is beyond the control of the enterprise. Still further, third-party entities may redirect their website traffic to other third-parties that may be geolocated in different countries, which may include geolocations that violate enterprise policies, jurisdictional regulations, or other controls or requirements.

Examples of privacy invading actions include obtaining personal information from the customer and/or enterprise-user and utilizing it for purposes that the customer, enterprise-user and/or the enterprise did not intend. This also includes loading programs on to the computing device of the customer and/or enterprise-user without the knowledge of the customer, enterprise-user and/or the enterprise. Moreover, malevolent acts include the inserting malware on the computing device of the customer and/or enterprise-user without the knowledge and consent of the customer and/or enterprise-user. The security issues include use of the information of the customer and/or enterprise-user that violate codes of conduct or even laws of certain jurisdictions and potential security vulnerabilities at the third-party entity that may allow an external party to enter the server of the third-party entity and compromise the information of customer and/or enterprise-user that accessed, or where part of, the customer data of the enterprise leading to potential fraudulent activity against some of those customers and the resulting financial liability of the enterprise that allowed the comprising of that customer data.

Another problem with an enterprise outsourcing key functions to cloud based services and/or SaaS applications is that third-party entities may unilaterally change the way that they do business with an enterprise, preventing the enterprise from properly monetizing or using data from their own enterprise data or customers. Unfortunately, in these situations, enterprise and/or customer data is shared with a broad range of application providers (i.e., third-party entities) and the provider relationships (i.e., enterprise to third-party entity relationships) are constantly changing. Furthermore, a compromised provider (i.e., third-party entity) may become a source of threats or breach for the enterprise.

In this application, the term first-party entity (or simply “first-party”) refers to enterprise. Second-party entities (or simply “second-party”) are enterprise approved and agented parties (i.e., entities) that operate under the authority and act as an agent on behalf of the enterprise. Examples of known second-party entities include content delivery networks and same-site analytics services. Such second-party entities are commonly obligated under contract to share data with the enterprise and are controlled and configurable according to the preferences of the enterprise. Conversely, third-party entities deliver services through their own distinct web domains and only have symbiotic relationships to the enterprise. As such, enterprises only have circumstantial knowledge and control over the operations of the third-party entities. Examples of known third-party entities include Internet storage services, financial services, cross-site social, or advertising services.

Prior to the use cloud-based services and/or SaaS applications, an enterprise generated all the needed key functionality on-site at one or more physical locations that included one or more servers to perform the key functionality desired by the enterprise. These servers were connected together as one or more local area networks (“LANs”). The enterprise may have a head-office located at a certain location and one or more remote regional offices located at other locations. Generally, the head-office included at least one LAN that connected all the servers located at the head-office and a number of computing devices (such as, for example, desktop or mobile computers) of local-users at the head-office. Similarly, each regional office may also include at least one LAN connecting all the servers located at the regional office and a number of computing devices of regional-office-users at the regional office. Moreover, a number of remote-users may also be connected to the LAN of the head-office via the dial-in or the Internet.

In this situation, it is appreciated by those of ordinary skill in the art that the LANs of the regional offices and remote-users may be in signal communication with the LAN of the head-office via a secure network connection such as, for example, a virtual private network (“VPN”) that creates a secure communication tunnel through the Internet and between the LANs of the regional offices and remote-users and LAN of the head-office creating a private network across a public network (i.e., the Internet). Moreover, the enterprise may include a webpage server that hosts a webpage for customers of the enterprise to access via the Internet. In this example, the webpage server would be physically located at the head-off and in signal communication with the LAN of the head-office and customers of the enterprise would interact with enterprise exclusively generated content. From a security perspective, this type of an implementation is secure because all of the electronic devices on the LANs of the head-office or regional offices are physically located on enterprise property and are operated, controlled, and managed exclusively by the enterprise without any outside access from third-party entities. Utilizing VPN modems/hubs, the LANs of the regional offices and LAN of head-office may be organized a single large closed and secure LAN. The remote-users may be mobile users that are at remote locations or traveling but have dial-up or Internet access. By utilizing VPN software/hardware of the computing devices of these remote-users, the remote-users are also in signal communication with the LAN of the head-office in a closed and secure fashion because the VPN software/hardware will make the remote-users act as if they were local-users on the LAN of the head-office.

Turning to FIG. 1, a system block diagram of an example of an implementation of a known LAN 100 for an enterprise (i.e., a business) having access to a public network such as, for example, the Internet 102 is shown. In this example, the LAN 100 is located in a head-office 104 of the enterprise and the LAN 100 is in signal communication with one or more regional office(s) 106 and a plurality of remote-users 108. The head-office 104 of the enterprise is the main physical location of the enterprise having a plurality of local-users 110 that may be employees of the enterprise. For example, the plurality of remote-users 108 may include a first local-user 112, second local-user 114, and third local-user 116. It is appreciated by those of ordinary skill in the art that while only three local-users 112, 114, and 116 are shown, the plurality of local-users may include any number needed for the operations of the enterprise. In this example, each local-user 112, 114, and 116 utilizes a computing device.

In this example, the enterprise may include a number of computer-based systems that assist with the operation of the enterprise such as, for example, a file server 118, storage server 120, print server 122, network-access-storage (“NAS”) 124, financial server 126, main server 128, webpage server 130, and other servers 132. The LAN 100 may include a network switch 134 that is in signal communication with the first local-user 112, second local-user 114, third local-user 116, file server 118, storage server 120, print server 122, NAS 124, financial server 126, main server 128, webpage server 130, and the other servers 132 via signal paths 136, 138, 140, 142, 144, 146, 148, 150, 152, 154, and 156, respectively. It is appreciated by those of ordinary skill in the art that the LAN 100 may be in signal communication with the Internet 102 via a router 158, VPN modem/hub 160, firewall 162, and signal path 164 all of which are well known elements in network computing. As an example, the router 158, VPN modem/hub 160, and firewall 162 may be integrated into a single device.

In this example, the plurality of remote-users 108 may include a first remote-user 166, second remote-user 168, and third remote-user 170 via signal paths 172, 174, and 176, respectively. Again, only three remote-users 166, 168, and 170 are shown for simplicity and there may be as many remote-users as necessary for the enterprise. In this example, each of the remote-users 166, 168, and 170 may include a VPN software and/or hardware to access the LAN 100 via the VPN hub 160 at the head-office 104. Moreover, in this example, the regional office(s) 106 may be a physical location having a LAN 178, a router 180, VPN hub 182, and firewall 184 in signal communication with the Internet 102 via signal path 186. The router 180, VPN hub 182, and firewall 184 may be similar to the same elements at the head-office 104 and may also be integrated into a single device. The LAN 178 may include multiple regional-users (not shown), a switch (not shown), and plurality of local regional servers (not shown).

In this example, the LAN 100, LAN 178, and remote-users 108 are part of a private network 190 that is closed and secure because no third-party entities are allowed to access the private network. The only potential access for customers of the enterprise is via the webpage server 130. All of the servers (i.e., file server 118, storage server 120, print server 122, NAS 124, financial server 126, main server 128, webpage server 130, and other servers 132) are located within the property of the enterprise and operated, controlled, and managed by personal of the enterprise without any third-party entities. Moreover, all of the signal paths 136, 138, 140, 142, 144, 146, 148, 150, 152, 154, 156, 164, 172, 174, 176, and 186 are either located within the property of the enterprise or are part of a VPN tunnel connecting to the LAN 100. As such the private network 190 is very secure because the enterprise controls the entire private network 190.

Unfortunately, as discussed earlier, the modem tread is to out-source many of the server functions shown in FIG. 1 to third-party entities that offer to provide those functions at cost levels that are significantly below the costs of acquiring, operating, and maintaining these servers in-house for the enterprise. The result is that modern enterprises need to balance the cost savings of out-sourcing key functions of the enterprise against the potential risks with allowing third-party entities to have access to and control enterprise and customer data of the enterprise. As such, there is a need for a system and method to allow an enterprise to utilize modern cloud based services and/or SaaS applications while still maintaining the security of a private network.

### SUMMARY

Described is a content server for establishing a virtual private network environment (“VPNE”) for application unification over a public network for an enterprise having a plurality of enterprise-users, where the public network has one or more public network sites and applications. The content server includes one or more processing units and a computer-readable media storing instructions. When executed by the one or more processing units, the instructions cause the content server to perform operations that include: receiving, as an intermediary, a request from a computing device of the enterprise for information content from a specific public network site of the one or more public network sites and applications; requesting the information content from the specific public network site; receiving, from the specific public network site, the information content within a first data; detecting a link for external information within the first data, wherein the external information is located on an external server that is external to the specific public network site; receiving the external information from the external server; modifying the first data from the specific public network site with the external information to produce a modified information content; and sending the modified information content to the computing device.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of an implementation a known local area network (“LAN”) for an enterprise (i.e., a business) having access to a public network such as, for example, the Internet.

FIG. 2 is a system block diagram of an example of an implementation of a virtual private network environment (“VPNE”) for application unification over a public network for an enterprise (i.e., a business) having access to the public network such as, for example, the Internet in accordance with the present disclosure.

FIG. 3 is a system block diagram of an example of another implementation of a VPNE for application unification over a public network for an enterprise having access to the public network such as, for example, the Internet in accordance with the present disclosure.

FIG. 4 is a system block diagram of an example of an implementation of the content server shown in FIGS. 2 and 3 in accordance with the present disclosure.

FIG. 5 is a system block diagram of an example of yet another implementation of a VPNE for application unification over a public network for an enterprise having access to the public network such as, for example, the Internet in accordance with the present disclosure.

FIG. 6 is a system block diagram of an example of an implementation of the content server shown in FIGS. 2-5 in accordance with the present disclosure.

FIG. 7 is a system diagram of an example of an implementation of components of a device, such as a device of the one or more devices, configured to receive requests from the computing device, send requests for data from the third-party entities, receiving data from the third-party entities, and sending the data to the computing device, respectively, in accordance with the present disclosure.

FIG. 8 is a system block diagram of an example of another implementation of a content server in accordance with the present disclosure.

FIG. 9 is a flowchart of an example of an implementation of a method of operation of the content server in accordance with the present disclosure.

### DETAILED DESCRIPTION

A content server for establishing a virtual private network environment (“VPNE”) for application unification over a public network for an enterprise having a plurality of enterprise-users is described, where the public network has one or more public network sites and applications. The content server includes one or more processing units and a computer-readable media storing instructions. When executed by the one or more processing units, the instructions cause the content server to perform operations that include: receiving, as an intermediary, a request from a computing device of the enterprise for information content from a specific public network site of the one or more public network sites and applications; requesting the information content from the specific public network site; receiving, from the specific public network site, the information content within a first data; detecting a link for external information within the first data, wherein the external information is located on an external server that is external to the specific public network site; receiving the external information from the external server; modifying the first data from the specific public network site with the external information to produce a modified information content; and sending the modified information content to the computing device.

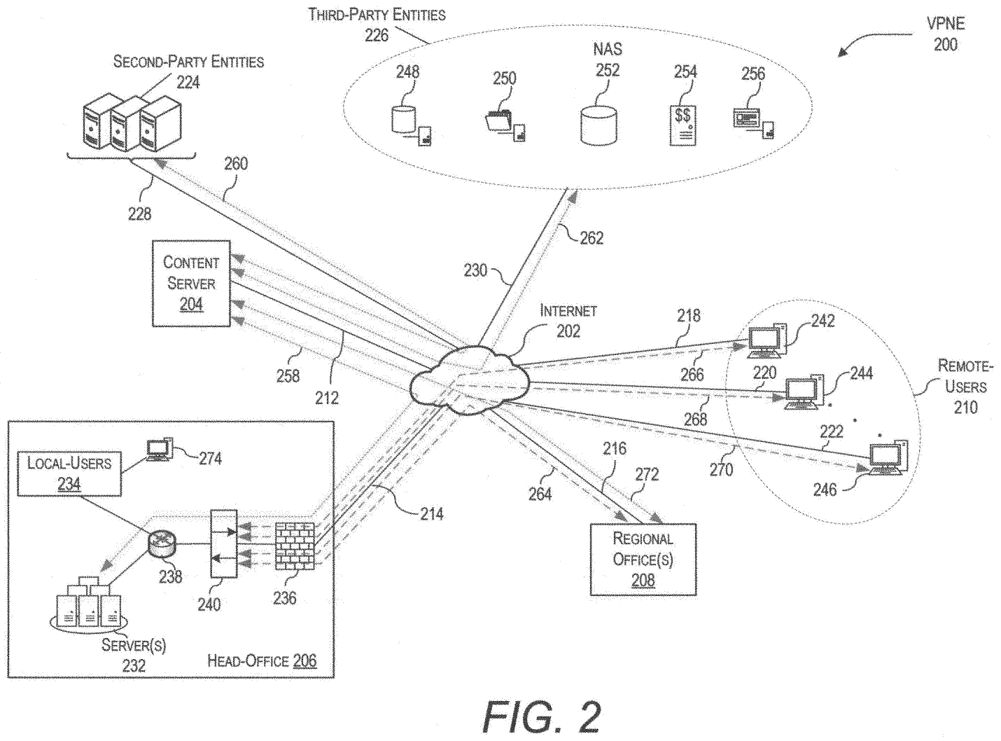

Various examples, scenarios, and aspects are described below with reference to FIGS. 2-9.

In FIG. 2, a system block diagram is shown of an example of an implementation of a VPNE 200 for application unification over a public network for an enterprise (i.e., a business) having access to the public network such as, for example, the Internet 202. In this example, the VPNE 200 may include a content server 204, head-office 206, at least one regional office 208, and a plurality of remote-users 210 of the enterprise, all in signal communication with the Internet 202 via signal paths 212, 214, 216, 218, 220, and 222, respectively. The VPNE 200 may also include a plurality of second-party entities 224 and third-party entities 226 in signal communication with the Internet 202 via signal paths 228 and 230, respectively.

In this example, the head-office 206 may include at least one server 232, plurality of local-users 234, firewall 236, local area network (“LAN”) router 238, and virtual private network (“VPN”) modem/hub 240. Similarly, the regional office 208 may include at least one server (not shown), plurality of regional-office-users (not shown), firewall (not shown), LAN router (not shown), and a VPN modem/hub (not shown). The remote-users 210 may include a first remote-user 242, second remote-user 244, and third remote-user 246. It is appreciated by those of ordinary skill in the art that while only three remote-users 242, 244, and 246 are shown, the plurality of remote-users 210 may include any number needed for the operations of the enterprise. In this example, each local-user of the plurality of local-users 234, regional-office-user, and remote-user 242, 244, and 246 utilizes a computing device to communicate with the VPNE 200. The third-party entities 226 may include, for example, a number of computer based systems that assist with the operation of the enterprise such as, for example, a storage server 248, file server 250, network-access-storage (“NAS”) 252, financial server 254, and webpage server 256. Instead of servers, these third-party entities 226 appear as website applications to the enterprise and enterprise-users (i.e., local-users 234, remote-users 210, regional-office-users, and servers 232 at the head-office 206 and servers at the regional office 208).

The at least one server 232, local-users 234, remote-users 210, and regional-office-users or servers may need access to and utilization of specific entities of the second-party entities 224 or third-party entities 226 because some of the functions of the enterprise have been outsourced to the external entities (i.e., second-party entities 224 or third-party entities 226) from the enterprise as cloud based services and/or Software-as-a-Service (“SaaS”) applications. In this example, none of these enterprise entities (i.e., the servers 232, local-users 234, remote-users 210, and regional-office-users or servers) within the VPNE 200 are allowed to directly communicate with the third-party entities 226 and optionally the second-party entities 224.

In this example, all communications with any of the third-party entities 226 is through content server 204. Additionally, all communications between the head-office 206, regional-office(s) 208, and remote-users 210 may be via VPN tunnels (i.e., encrypted links between a device and network over a public network). With this combination, the VPNE 200 allows the enterprise to have a closed private network for its enterprise users (i.e., local-users 234, remote-users 210, regional-office-users, and servers 232 at the head-office 206 and regional office 208) over a public network such as, for example, the Internet 202.

As such, the head-office 206 is in signal communication with the content server 204 via a combined signal path 258 and the content server 204 is also in signal communication with the second-party entities 224 and third-party entities 226 via combined signal paths 260 and 262, respectively. Moreover, the regional office(s) 208 is in signal communication with the head-office 206 via a combined signal path 264 and the remote-users 242, 244, and 246 are in signal communication with the head-office 206 via combined signal paths 266, 268, and 270, respectively.

In this example, the combined signal path 258 may be an Internet link (i.e., a hypertext transfer protocol (“HTML”) hyperlink) that includes signal paths 212 and 214 and the Internet 202 from the head-office 206 to the content server 204; the combined signal path 260 may be an Internet link that includes signal paths 212 and 228 and the Internet 202 from the content server 204 to the second-party entities 224; and the combined signal path 262 may be an Internet link that includes signal paths 212 and 230 and the Internet 202 from the content server 204 to the third-party entities 226. Moreover, the combined signal path 264 may be a VPN tunnel that includes signal paths 214 and 216 and the Internet 202 from the head-office 206 to the regional office 208; the combined signal path 264 may be a VPN tunnel that includes signal paths 214 and 218 and the Internet 202 from the head-office 206 to the first remote-user 242; the combined signal path 264 may be a VPN tunnel that includes signal paths 214 and 220 and the Internet 202 from the head-office 206 to the second remote-user 244; and the combined signal path 264 may be a VPN tunnel that includes signal paths 214 and 222 and the Internet 202 from the head-office 206 to the third remote-user 246.

In this example, the content server 204 may optionally be in signal communication with a server at the regional office 208 via an optional combined signal path 272. The optional combined signal path 272 may be an Internet link that includes signal paths 212 and 216 and the Internet 202 from the regional office 208 to the content server 204.

The VPNE 200 allows the enterprise to have a closed private network for its enterprise users over a public network such as, for example, the Internet 202. In general, all communications between the enterprise users may be via local area routers within the head-office 206 (i.e., router 238) and regional office(s) 208 and via VPN tunnel connections between the head-office 206, regional office(s) 208, and remote-users 210 such that all the enterprise-users (i.e., local users 234, regional-office-users of the regional office(s) 208, and remote-users 210) appear to be connected to a single wide area network (“WAN”) that is private, controlled, and managed by the enterprise. In this example, the content server 204 may be located at the head-office 206 or remote from the head-office 206 but securely connected to the enterprise network (as example, via a VPN tunnel).

The content server 308 may be a software and/or hardware module, device, or component that may be optionally integrated with a server of the one or more servers 232.

It is appreciated by those skilled in the art that the circuits, components, modules, and/or devices of, or associated with, the content server 204 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

In an example of operation, a local-user 274 (of the local-users 234) works within the head-office 206 and may communicate with other local-users 234 and local resources such as the one or more servers 232 via the LAN of the head-office 206 that utilizes the LAN router 238. Because of the WAN of the enterprise established by the VPN, the local-user 274 is also able to communicate with regional-office-users and regional-office resources at the regional office(s) 208 and the plurality of remote-users 210 as if these enterprise-users and resources were also located at the head-office 206. However, once the local-user 274 needs to utilize some of the outsourced resources of the enterprise, the local-user 274 needs to communicate with one or more third-party entities of the plurality of third-party entities 226 that are located remote from the head-office 206, the local-user 274 will need to access these third-party entities via the Internet 202.

In general, the local-user 274 (or the any of the other enterprise-users) utilizes a computing device (not shown) that may be a personal computer (including a desktop, tower, or other similar devices), portable computer (including a laptop, notebook, or tablet computer, or other similar devices), mobile device (including a tablet, smartphone, or other similar devices), server, or other type of computing device capable of connecting to the enterprise resources, other enterprise-users, second-party entities 224 and/or third-party entities 226 over the Internet 202. The computing device is operated by an enterprise-user (such as the local-user 274) via a browser (not shown) running on the display screen (not shown) of a video display (not shown) of the computing device.

In this example, the local-user 274 utilizes the browser (that is running on the computing device) to access a website (or web application or enterprise portal) running on a third-party entity of the third-party entities 226. Because these third-party entities 226 are cloud based services and/or SaaS applications, they are generally websites or Web applications having Internet protocol (“IP”) addresses that if entered in a browser of a computing device of the local-user 274 would normally direct the computing device to the third-party entity if the content server 204 were not present. Since the content server 204 is present in the VPNE 200, the signal path directly from the computing device of the local-user 274 to the third-party entity does not exist because the all communications between the computing device and the third-party entity will be controlled and managed by the content server 204 via signal paths 258 and 262. The content server 204 prevents this situation because the content server 204 is a proxy server that acts as an intermediary for requests from clients (i.e., the computing device) seeking resources from other servers (i.e., the third-party entity of the plurality of third-party entities 226). Specifically, the content server 204 is a “unity hub” that intercepts the request from the browser and acts on behalf of the enterprise in a manner that may be transparent to the computing device, browser, and end-user (i.e., enterprise-user).

It is appreciated by those of ordinary skill in the art that the content server 204 may intercept the requests from the browser by utilizing various interceptions mechanisms. For example, the content server 204 may utilize domain name system (“DNS”) delegation. As another example, content server 204 may be deployed in a physical or virtual datacenter of the enterprise as a front-end proxy. Moreover, in another example, the content server 204 acts in the place of an existing origin in a content delivery network (“CDN”) configuration when the enterprise utilizes a CDN for delivery of an end-user data of the enterprise user from the computing device.

The content server 204 is a proxy server or a proxy-like module that intermediates all or selected interactions between parties (i.e., the enterprise users or enterprise resources and the second-party entities 224 and/or third-party entities 226). In general, the content server 204 receives requests for content from end-users (i.e., enterprise-users or enterprise resources) and relays the requests to second-party entities 224, third-party entities 226, or both.

In this example, it is appreciated by those of ordinary skill in the art that enterprise resources that are non-enterprise-users may also request access to either the second-party entities 224 or third-party entities 226. These enterprise resources may include, for example, devices and/or software modules associated with or running on servers of the enterprise (such as, for example, servers 232) that may require data or other information from outsourced services that are provided by the second-party entities 224 and/or third-party entities 226. These enterprise resources may be completely automated and not require the interaction of an enterprise-user.

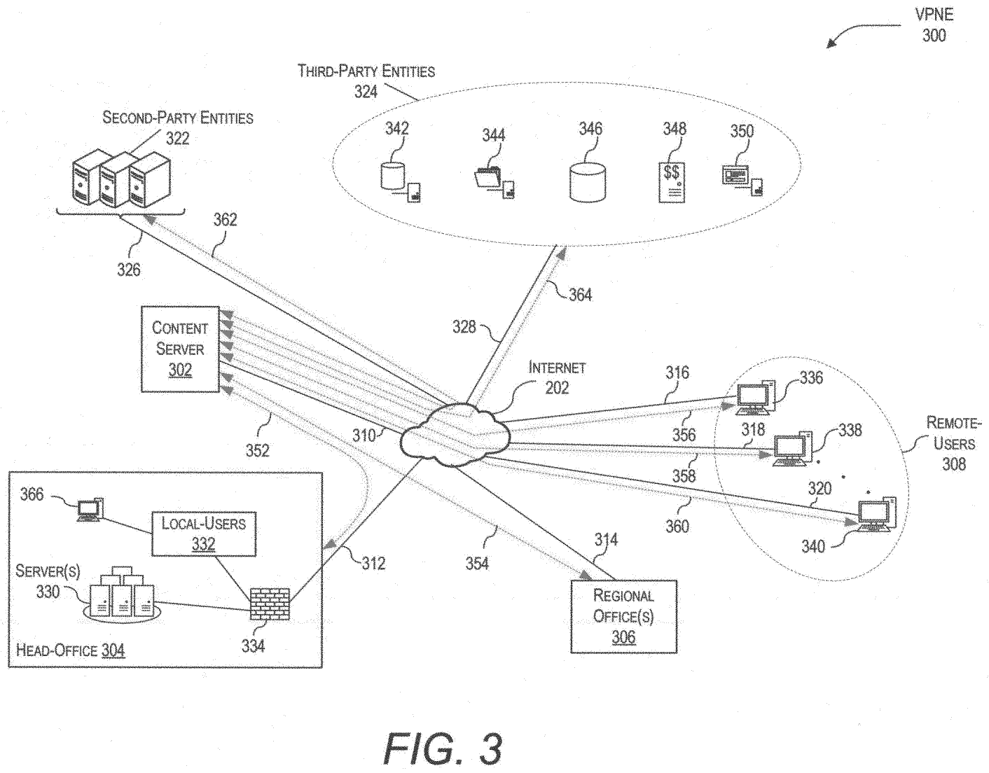

Turning to FIG. 3, a system block diagram is shown of an example of another implementation of a VPNE 300 for application unification over a public network for an enterprise (i.e., a business) having access to the public network such as, for example, the Internet 202. In this example, the VPNE 300 may include a content server 302, head-office 304, at least one regional office 306, and a plurality of remote-users 308 of the enterprise, all in signal communication with the Internet 202 via signal paths 310, 312, 314, 316, 318, and 320, respectively. The VPNE 300 may also include a plurality of second-party entities 322 and third-party entities 324 in signal communication with the Internet 202 via signal paths 326 and 328, respectively.

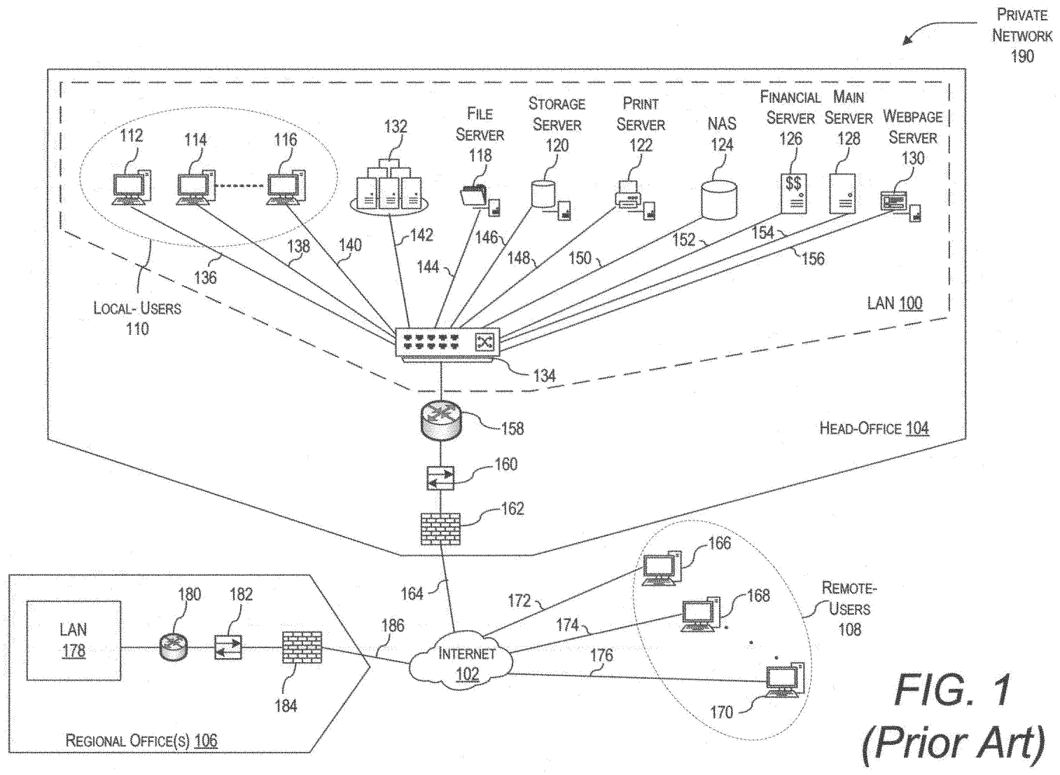

Similar to the example described in relation to FIG. 1, in this example, the head-office 304 may include at least one server 330, plurality of local-users 332, firewall 334, and VPN modem/hub (not shown). Similarly, the regional office 306 may include at least one server (not shown), plurality of regional-office-users (not shown), firewall (not shown), and a VPN modem/hub (not shown). The remote-users 308 may include a first remote-user 336, second remote-user 338, and third remote-user 340.

It is appreciated by those of ordinary skill in the art that while only three remote-users 336, 338, and 340 are shown, the plurality of remote-users 308 may include any number needed for the operations of the enterprise. In this example, each local-user of the plurality of local-users 332, regional-office-user, and remote-user 336, 338, and 340 utilizes a computing device to communicate with the VPNE 300. The third-party entities 324 may include, for example, a number of computer based systems that assist with the operation of the enterprise such as, for example, a storage server 342, file server 344, NAS 346, financial server 348, and webpage server 350. Instead of servers, each of these third-party entities 324 appear as website applications to the enterprise and enterprise-users (i.e., local-users 332, remote-users 308, regional-office-users, and enterprise resources such as, for example, servers 330 at the head-office 304 and servers at the regional office 306).

The at least one server 330, local-users 332, remote-users 308, and regional-office-users or servers at the regional offices 306 may need access to, and utilization of, specific second-party and/or third-party entities of the second-party entities 322 or third-party entities 324 because some of the functions of the enterprise have been outsourced to the external entities (i.e., second-party entities 322 or third-party entities 324) from the enterprise as cloud based services and/or SaaS applications. In this example, none of these enterprise entities (i.e., the servers 330, local-users 332, remote-users 308, and regional-office-users or regional office servers) within the VPNE 300 are allowed to directly communicate with the third-party entities 324 and/or the second-party entities 322.

Similar to the previous example described in relation to FIG. 1, in this example, all communications with any of the third-party entities 324 is through content server 302. As such, the head-office 304 is in signal communication with the content server 302 via a combined signal path 352 and each regional office 306 is in signal communication with the content server 302 via a combined signal path 354. In this example, the combined signal path 352 includes signal paths 310 and 312 and the Internet 202. Similarly, the combined signal path 354 includes signal paths 310 and 314 and the Internet 202. Unlike the previous example described in relation to FIG. 1, in this example, the first remote-user 336 is in signal communication with the content server 302 via combined signal path 356; the second remote-user 338 is in signal communication with the content server 302 via combined signal path 358; and the third remote-user 340 is in signal communication with the content server 302 via combined signal path 360. The combined signal path 356 includes signal paths 316 and 310 and the Internet 202; the combined signal path 358 includes signal paths 318 and 310 and the Internet 202; and the combined signal path 360 includes signal paths 320 and 310 and the Internet 202. The second-party entities 322 are in signal communication with the content server 302 via combined signal path 362 and the third-party entities 324 are in signal communication with the content server 302 via combined signal path 364. The combined signal path 362 includes signal paths 326 and 310 and the Internet 202 and the combined signal path 364 includes signal paths 328 and 310 and the Internet 202.

Because these third-party entities 324 are cloud based services and/or SaaS applications, they are generally websites or Web applications having IP addresses that if entered in a browser of a computing device of an enterprise-user would normally direct the computing device to the third-party entity if the content server 302 were not present. As described earlier, the content server 302 prevents this situation because the content server 302 is a proxy server that acts as an intermediary for requests from clients (i.e., the computing devices of the enterprise-users) seeking resources from other servers (i.e., the second-party entities 322 or third-party entities 324). Specifically, the content server 302 is a proxy server that intercepts the requests from the browsers of the computing devices of the enterprise-users and acts on behalf of the enterprise in a manner that may be transparent to the computing devices, browsers, and enterprise-users.

As before, in this example, the VPNE 300 allows the enterprise to have a closed private network for its enterprise users over a public network such as, for example, the Internet 202. Unlike the example described in relation to FIG. 1, all attempts to directly access the second-party entities 322 and/or third-party entities 324 are first directed to the content server 302 and then the content server 302 contacts and accesses the desired second-party entities 322 and/or third-party entities 324 and then passes the information and/or data back and forth between the enterprise users and the second-party entities 322 and/or third-party entities 324 without going through the head-office 304 as described in relative to the VPNE 200 described in relation to FIG. 1.

In this example, the enterprise users or resources remote from the head-office 304 (i.e., the remote users 308, regional-office-users, and servers at the regional offices 306) do not utilize a VPN tunnel or other secure connection with the head-office 304 before communicating directly to the content server 302. In one example, the VPNE 300 may be configured such that the enterprise users and enterprise resources may communicate directly with each other via VPN tunnels or other secure connections as described in relation to FIG. 1, while also allowing semi-direct communication with the second-party entities 322 and third-party entities 342 via the content server 302 without having to first go to a server of the one or more servers 330 of the head-office 304 as described in relation to FIG. 1.

In an example of operation, a local-user 366 (of the local-users 332) works within the head-office 304 and may communicate with other local-users 304 and local resources such as the one or more servers 330 via the LAN of the head-office 366 that utilizes the LAN router (not shown). Because of the WAN of the enterprise established by the VPN, the local-user 366 is also able to communicate with regional-office-users and regional-office resources at the regional office(s) 306 and the plurality of remote-users 308 as if these enterprise-users and resources were also located at the head-office 304. However, once the local-user 366 needs to utilize some of the outsourced resources of the enterprise, the local-user 366 needs to communicate with one or more third-party entities of the plurality of third-party entities 324 that are located remote from the head-office 304, the local-user 366 will need to access these third-party entities via the Internet 202.

As described earlier, in general, the local-user 366 (or the any of the other enterprise-users) utilizes a computing device (not shown) that may be a personal computer (including a desktop, tower, or other similar devices), portable computer (including a laptop, notebook, or tablet computer, or other similar devices), mobile device (including a tablet, smartphone, or other similar devices), server, or other type of computing device capable of connecting to the enterprise resources, other enterprise-users, second-party entities 322 and/or third-party entities 324 over the Internet 202. The computing device is operated by an enterprise-user (such as the local-user 366) via a browser (not shown) running on the display screen (not shown) of a video display (not shown) of the computing device.

In this example, the local-user 366 utilizes the browser (that is running on the computing device) to access a website (or web application or enterprise portal) running on a third-party entity of the third-party entities 324. Similar to the local-user 366, the remote-users 308 and regional-office-users also utilize browsers to access the website running on a third-party entity of the third-party entities 324. Because these third-party entities 324 are cloud based services and/or SaaS applications, they are generally websites or Web applications having IP addresses that if entered in a browser of a computing device of the local-user 366 would normally direct the computing device to the third-party entity if the content server 302 were not present. As before, since the content server 302 is present in the VPNE 300, the signal path directly from the computing device of the local-user 366 to the third-party entity does not exist because the all communications between the computing device and the third-party entity will be controlled and managed by the content server 302 via signal paths 352 and 362. The content server 302 prevents this situation because the content server 302 is a proxy server that acts as an intermediary for requests from clients (i.e., the computing device) seeking resources from other servers (i.e., the third-party entity of the plurality of third-party entities 324). Specifically, the content server 302 is a unity hub that intercepts the request from the browser and acts on behalf of the enterprise in a manner that may be transparent to the computing device, browser, and end-user (i.e., enterprise-user).

In a similar fashion, if the first remote-user 336 attempts to directly access a third-party entity of the plurality of third-party entities 324, the content server 302 prevents the direct access by intercepting the request from the first remote-user 336 via combined signal path 356 and access the desired third-party entity via the combined signal path 364. The content server 302 then intercepts and controls the communication of information and/or data between the desired third-party entity and the first remote-user 336. The content server 302 performs the same procedure for all the remote-users 308 and regional-office-users external to the home-office 304.

It is appreciated by those of ordinary skill in the art that the content server 302 may intercept the requests from the browser by utilizing various interceptions mechanisms. For example, the content server 302 may utilize DNS delegation. As another example, content server 302 may be deployed in a physical or virtual datacenter of the enterprise as a front-end proxy. Moreover, in another example, the content server 302 acts in the place of an existing origin in a CDN configuration when the enterprise utilizes a CDN for delivery of an end-user data of the enterprise user from the computing device.

The content server 302 is a proxy server or a proxy-like module that intermediates all or selected interactions between parties (i.e., the enterprise users or enterprise resources and the second-party entities 322 and/or third-party entities 324). In general, the content server 302 receives requests for content from end-users (i.e., enterprise-users or enterprise resources) and relays the requests to second-party entities 322, third-party entities 324, or both.

In this example, it is appreciated by those of ordinary skill in the art that enterprise resources that are non-enterprise-users may also request access to either the second-party entities 322 or third-party entities 324. These enterprise resources may include, for example, devices and/or software modules associated with or running on servers of the enterprise (such as, for example, servers 330) that may require data or other information from outsourced services that are provided by the second-party entities 322 and/or third-party entities 324. These enterprise resources may be completely automated and not require the interaction of an enterprise-user.

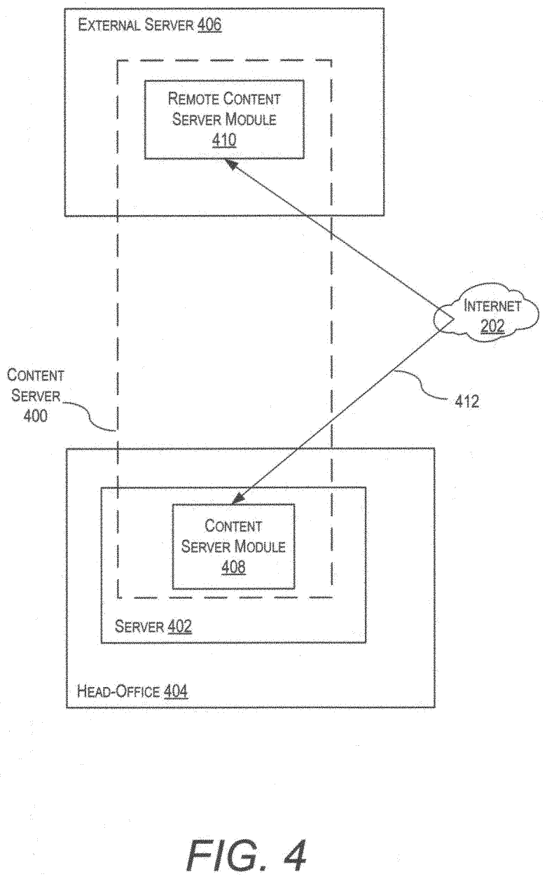

FIG. 4 is a system block diagram of an example of an implementation of a content server 400 in accordance with the present disclosure. The content server 400 may be both part of a server 402 located at the head-office 404 and an external server 406 that is located at a remote location from the head-office 404. In this example, the content server 400 may include content server module 408 located within (or in association with) the server 402 at the head-office 404 and a remote content server module 410 located (or in association with) the external server 406. The content server module 408 and remote content server module 410 may be in signal communication via combined signal path 412 that passes through the Internet 202. It is appreciated that the content server module 408 may optionally be located at a regional office (not shown) instead of the head-office 404.

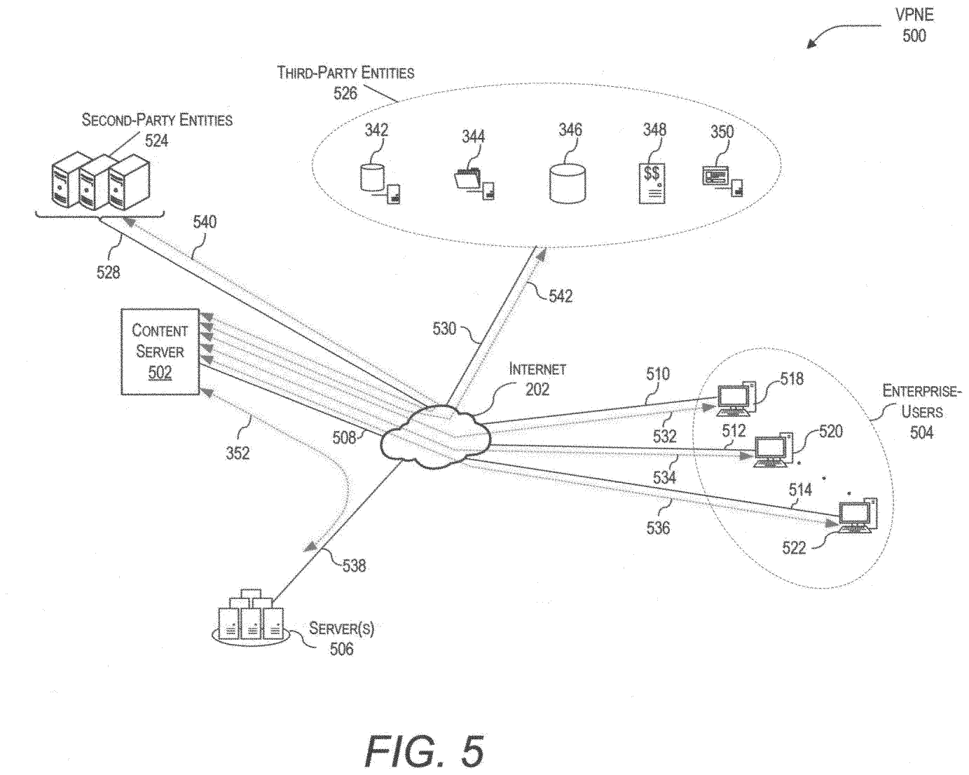

In FIG. 5, a system block diagram of an example of yet another implementation of a VPNE 500 for application unification over a public network (the Internet 202) is shown in accordance with the present disclosure. In this example the VPNE 500 may be for an enterprise that is completely virtual in that it does not have a “brick-and-mortar” head-office or regional offices as discussed in relation to FIGS. 2 and 3. The VPNE 500 is a closed private network for the enterprise that is a virtual business entity and may include the content server 502, plurality of enterprise-users 504, and one or more servers 506 in signal communication with the Internet 202 via signal paths 508, 510, 512, 514, and 516, respectively. In this example, the plurality of enterprise-users 504 includes a first enterprise-user 518, second enterprise-user 520, and third enterprise-user 522 where the a first enterprise-user 518 is in signal communication with the Internet 202 via signal path 510, second enterprise-user 520 is in signal communication with the Internet 202 via signal path 512, and third enterprise-user 522 is in signal communication with the Internet 202 via signal path 514. As before, the VPNE 500 may be in signal communication with the second-party entities 524 and third-party entities 526 via signal paths 528 and 530, respectively through the Internet 202. Similar to the example described in relation to FIG. 3, the content server 502 is in signal communication with the first enterprise-user 518 via a combined signal path 532; the content server 502 is in signal communication with the second enterprise-user 520 via a combined signal path 534; the content server 502 is in signal communication with the third enterprise-user 522 via a combined signal path 536; the content server 502 is in signal communication with the at least one server 506 via a combined signal path 538; the content server 502 is in signal communication with the second-party entities 524 via a combined signal path 540; and the content server 502 is in signal communication with the third-party entities 526 via a combined signal path 542. The combined signal path 532 includes the signal paths 508 and 510 and the Internet 202; the combined signal path 534 includes the signal paths 508 and 512 and the Internet 202; the combined signal path 536 includes the signal paths 508 and 514 and the Internet 202; the combined signal path 538 includes the signal paths 508 and 538 and the Internet 202; the combined signal path 540 includes the signal paths 508 and 528 and the Internet 202; and the combined signal path 540 includes the signal paths 508 and 530 and the Internet 202.

In this example, the enterprise-users 504 are generally located in different locations from each other (as an example, at the residences of each enterprise-user 518, 520, and 522) and the at least one server 506 may also be located optionally in a different location from the enterprise-users 504 or at the location of a single enterprise-user 518, 520, or 522 of the plurality of enterprise-users 504. The content server 502 operates in a similar fashion to the content server 302 shown in FIG. 3 except that in this example all communication between the enterprise-users 504, at least one server 506, second-party entities 524, and third-party entities 526 are passed over the Internet 202 and through the content server 502. In this example, the content server 502 includes additional modules, components, and/or devices such as, for example, servers, VPN equipment, and other related network hardware and software capable of securely communicating with enterprise-users 504 and at least one server 506 so as to simulate a virtual private network were all the enterprise-users 504 and at least one server 506 operate as if they were all located in the same office on a LAN. Moreover, all requests for access or content from any second-party entities of the plurality of second-party entities 524 or any third-party entities of the plurality of third-party entities 526 are intercepted, controlled, and managed by the content server 502 acting as a proxy for the enterprise.

Turning back to FIGS. 2-5, it is appreciated by those of ordinary skill in the art that in this examples, the content server 204, 302, 400, or 502 are in signal communication with one or more telecommunication networks via signal paths 212, 310, 412, and 508, respectively. In these example, the one or more telecommunication networks may include, for example, public networks such as the Internet (as was described previously as Internet 202), private networks such as an institutional and/or personal intranet, or some combination of private and public networks.

The one or more telecommunication networks may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. The one or more telecommunication networks 112 may utilize communications protocols, including packet-based and/or datagram-based protocols such as IP, transmission control protocol (“TCP”), user datagram protocol (“UDP”), or other types of protocols. Moreover, the one or more telecommunication networks may also include a number of devices that facilitate network communications and/or form a hardware basis for the networks, such as switches, routers, gateways, access points, firewalls, base stations, repeaters, backbone devices, and the like.

In some examples, the one or more telecommunication networks may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11 n, and so forth), and other standards.

In this example, each computing device of an enterprise-user may be a computer, portable computer, server, mobile device (such as a smart telephone, tablet, etc.), etc. In general, the computing device may include one or more computing devices that operate in a cluster or other grouped configuration to share resources, balance load, increase performance, provide fail-over support or redundancy, or for other purposes. For instance, the computing device may belong to a variety of classes of devices such as traditional server-type devices, desktop computer-type devices, and/or mobile-type devices.

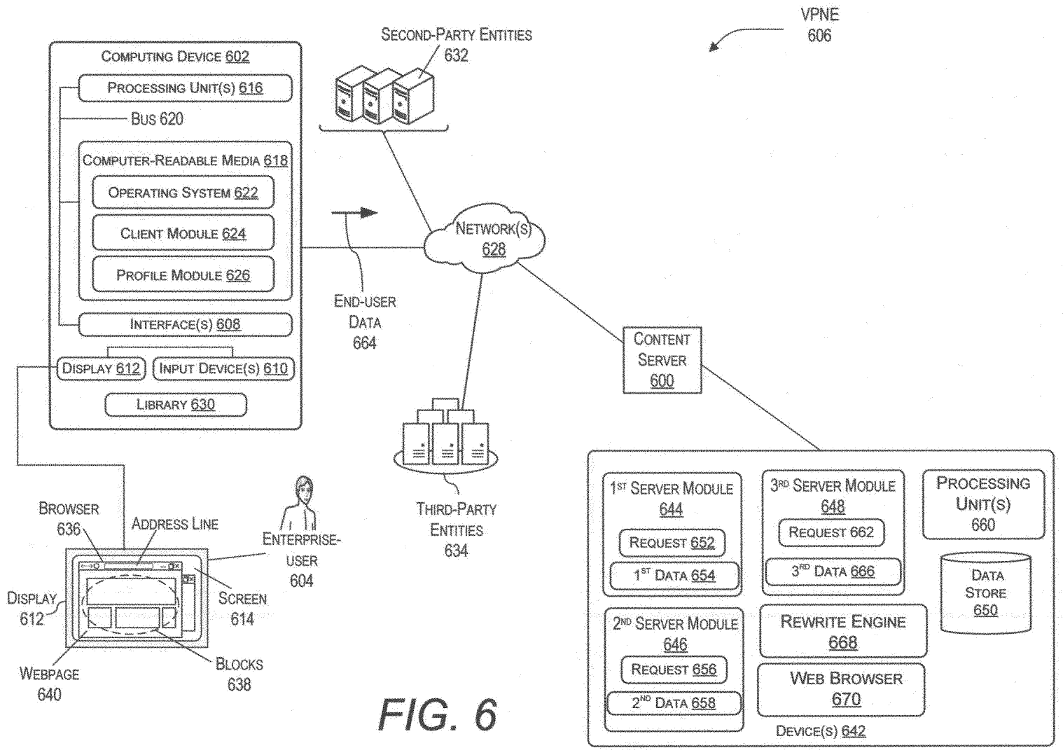

Turning to FIG. 6, a system block diagram of an example of an implementation of the content server 600 is shown in accordance with the present disclosure. The content server 600 and computing device 602 of an enterprise-user 604 are part of the VPNE 606. In this example, only a single enterprise-user 604 is shown for the simplicity and the purpose of illustration, however, it is appreciated that there may be any number of enterprise-users as described earlier.

In some implementations, the computing device 602 includes one or more input/output (“I/O”) interfaces 608 that enable communications with input/output devices such as user input devices 610 including peripheral input devices (e.g., a game controller, a keyboard, a mouse, a pen, a voice input device, a touch input device, a gestural input device, and the like) and/or output devices including peripheral output devices (e.g., a display 612, a printer, audio speakers, a haptic output device, and the like). The computing device 302 may also include a combination of two or more devices, such as a mobile phone in combination with a wearable device. In this example, the computing device 602 will include the display that includes a display screen 614 to displaying information to the enterprise-user 604.

The computing device 602 may represent any type of computing device having one or more processing units 616 in signal communication to a computer-readable media 618 via a bus 620, which in some instances may include one or more of a system bus, a data bus, an address bus, a PCI bus, a Mini-PCI bus, and any variety of local, peripheral, and/or independent buses. Executable instructions stored on the computer-readable media 618 can include, for example, an operating system 612, a client communication module 624, a profile module 626, and other modules, programs, or applications that are loadable and executable by the one or more processing units 616.

The computing device 602 can also include the one or more interface(s) 608 to enable communications between the computing device 602 and other networked devices, such as the content server 600. The network interface(s) 608 can include one or more network interface controllers (“NICs”) or other types of transceiver devices to send and receive communications and/or data over the one or more networks 628 (that may be the Internet 202). In this example, the computing device 602 also includes the JavaScript library 630.

In this example of the VPNE 606, the computing device 602 utilizes its client communication module 624 to connect with the client server 600 and/or other external device(s) through the one or more telecommunication networks 628. In various examples, the computing device 602 utilizes its profile module 626 to generate user profiles for communicating with other devices (such as content server 600) over the one or more telecommunication networks 628. In general, a user profile may include one or more of an identity of a user (e.g., a name, a unique identifier (“ID”), etc.), a user avatar, personal data (e.g., age, title, position, etc.), location data, status data (e.g., online, offline, available, busy, etc.) and so forth.

The content server 600 may be any device, network, or system that can communicate with and act as a proxy intermediary between the enterprise-user 604, second-party entities 632, and third-party entities 634 in accordance with one or more features of the present disclosure. For example, the content server 600 may be in the form of a cloud proxy or cloud network made up of one or more servers.

In this example, the enterprise-user 604 is an individual (such as an employee of the enterprise) but may also be an automated device of software component of module (i.e., an enterprise resource) capable of interfacing with the computing device 602 to search the one of more telecommunication networks 5628. As an example, the computing device 602 may also include the browser 636, which is a software application (i.e., program) for browsing (i.e., searching and viewing information) the Internet 202, where the software application is stored on a memory unit within the computing device 602. At present, examples of known browsers 636 include, for example, Google Chrome® produced by Google LLC. of Mountain View, Calif., Mozilla Firefox® produced by Mozilla Foundation of Mountain View, Calif., Safari® produced by Apple, Inc. of Cupertino, Calif., and Internet Explorer® and Edge® produced by Microsoft Corporation of Redmond, Wash. The executable instructions of the browser 636 are loaded in the computer-readable media 618 for execution by the one or more processors 616 of the computing device 602. In general, the computer-readable media 618 is a computer or machine-readable medium that is a medium capable of storing data in a format readable by a computer and/or mechanical device rather than human readable.

The browser 636 may display information to the enterprise-user 604 on the display 612 of the computing device 602, which may be, for example, the screen 614 on a computer, television, or hand-held device. The displayed information on the display 612 may contain the one or more blocks 638 of content, which may include a publisher block that visually displays Internet content created by an entity of the second-party entities 632 or third-party entities 634.

As discussed earlier, the content server 600 acts as a proxy intermediary between the computing device 602 and the second-party entities 632 and/or third-party entities 634 and applies multiple network and content optimization techniques to achieve reduced latency and improved efficiency while controlling any delivered and shared information with the enterprise-user 604.

In this disclosure, the content server 600 may operate differently than convention Internet interactions to help improve the enterprise-user 604 experience.

Specifically, in a conventional system as described earlier, a second-party entity or third-party entity would communicate directly with the computing device 602 and the computing device 602 would resolve the domain name of the second-party entity or third-party entity and connect directly to a website of a web server of the second-party entity or third-party entity. The second-party entity or third-party entity would prepare the Internet content and directly push that content to the computing device 602 where the Internet content is rendered for delivery to the enterprise-user 604, via a webpage 640 that is a browser window of the browser 636 or the like, to be displayed in a block 638 on the display 612 either within the browser window or separate window displayed on the display 614.

In this example, the rendered content may also contains Internet hyperlink references to at least one other third-party entity of the plurality of third-party entities 634 that allows the at least one other third-party to directly deliver scripts, documents, or advertisements to the computing device 602, where these scripts, documents, or advertisements are executed along with the Internet content provided by the first third-party entity. In contrast, the content server 600 does not allow second-party entities 632 or third-party entities 634 to communicate directly with the computing device 602. Instead, the second-party entities 632 and third-party entities 634 communicate indirectly with the computing device 602 through the content server 600 that acts as a proxy intermediary.

In this example, the content server 600 includes one or more devices 642. The one or more devices 642 and/or components of the content server 600 can include distributed computing resources that communicate with one another and/or with the computing device 600, second-party entities 632, and the third-party entities 634 via the one or more telecommunication networks 628.

In various examples, the one or more devices 642 may operate in a cluster or other grouped configuration to share resources, balance load, increase performance, provide fail-over support or redundancy, or for other purposes. As an example, the one or more devices 642 of the content server 600 includes a first server module 644, second server module 646, third server module 648, and a data storage 650.

As an example, the first server module 644 is configured to receive, from the enterprise-user 604 (utilizing the computer device 602) a domain name resolution request for a third-party entity. Typically, the enterprise-user 604 will use a search engine link or type in a domain name with the input device 610 for the third-party entity rather than using an IP address. The domain name is converted to the IP address via a procedure called domain name service (“DNS”) resolution or DNS lookup in conventional fashion.

In this example, content server 600 will have IP address of the desired second-party entity or third-party entity associated with the content server 600 such that when the computing device 602 attempts to contact the second-party entity or third-party entity, the computing device 602 will receive the IP address for the contact server 600 instead of an IP address for the second-party entity or third-party entity. The content server 600 will have the IP address of the desired second-party entity or third-party entity associated with the content server 600 because the enterprise will only allow the enterprise-user 604 to access specific second-party entities of the plurality of second-party entities 632 or specific third-party entities of the plurality of third-party entities 634 that the enterprise has entered into contractual relationships with and thus those second-party entities and third-party entities are known to the enterprise allow with the corresponding IP addresses.

The computing device 602 thus connects to the content server 600 and requests 652 an Internet first data 654 from the second-party entity or third-party entity. In this example, the first data 654 may be, for example, a webpage. The first server module 644 receives the request 652 for the first data 654 and, in response, the content server 600 makes a request 656 for first data 654 from the second-party entity or third-party entity. The second-party entity or third-party entity receives the request 656 for the first data 654 and, in response, creates and sends the first data 654 to the second server module 646. The content server 600 then detects any redirects in the first data 654 from the second-party entity or third-party entity. If there is any redirects in the first data 654, the content server 600 modifies the redirects in the first data 654 to produce the second data 658 by, for example, rewriting the first data 654 to remove the redirects with one or more processing units 660 within the content server 600. The third server module 648 then requests 662 information data from a third-party entity (of the third-party entities 634) that the redirect was directed to. If any information from the enterprise-user 604 needs to be passed to the third-party entity, the content server 600 may cleanse and anonymize the enterprise-user data 664 prior to sending to the third-party entity. The third-server module 648 then receives the information from the third-party entity and combines it with the second data 658 to produce a third data 666. The content server 600 then transmits the third data 666 to the computing device 602.

The content server 600 may utilizes the flow of information to create a server-side browser-like environment. The browser-like environment is used to execute the modified Internet content including excised and/or rewritten redirect link blocks or scripts. The blocks or scripts of the redirects are thus getting executed as if they were on the computing device 602, while in a simulated browser-like environment that mimics the browser 636 of the computing device 602 with improved fidelity.

As an example, the communication with the third-party entity and the rewriting of the data is achieved by a server-side browser (i.e., at the content server 600) shadowing environment and/or end user-side (i.e., at the computing device 602) instrumentation. This approach may utilize Javascript and rewriting uniform resource locators (“URLs”) in Javascript in a corporate environment, where these functions may be implemented within a clientless or browser-based secure sockets layer (“SSL”) virtual private network (“VPN”) gateways providing secure remote access to internal resources. In general, URL rewriting allows a URL to be separated from a resource such that the URL and the resource that it leads to can be independent of each other. In this disclosure, URL rewriting (also known as URL manipulation) allows the enterprise-user 604 utilizing the computing device 602 to link to a URL of the third-party entity that has been rewritten to direct the link to the original URL to a new URL at the content server 600 in a way that is transparent to the computing device 602 and enterprise-user 604. In general, URL rewriting is a process of altering (often automatically by means of a software program) the parameters in a URL. It is a way of implementing URL mapping or routing within a Web app. The Web app is a client-server computer program that the client (i.e., the computing device 602) runs in the browser 636. In this example, a software program that automatically performs URL rewriting is generally known as rewrite engine. In this example, the one or more devices 642 of the content server 600 is shown also including a rewrite engine 668 module that is associated with a web browser application 670 on the content server 600, where the rewrite engine 668 may be a component of the web browser application 670 or a web application framework (also known as a web framework). The web framework is a software framework that is designed to support the development of web applications that include, for example, web services, web resources (i.e., a resource located on the one or more telecommunication networks 628), and web application programming interfaces (“APIs”).

In all of these examples, the one or more devices 642 of the content server 600 may also include the data storage 650 such as, for example, a memory unit to store any needed information related the first data 654, second data 658, or third data 666.

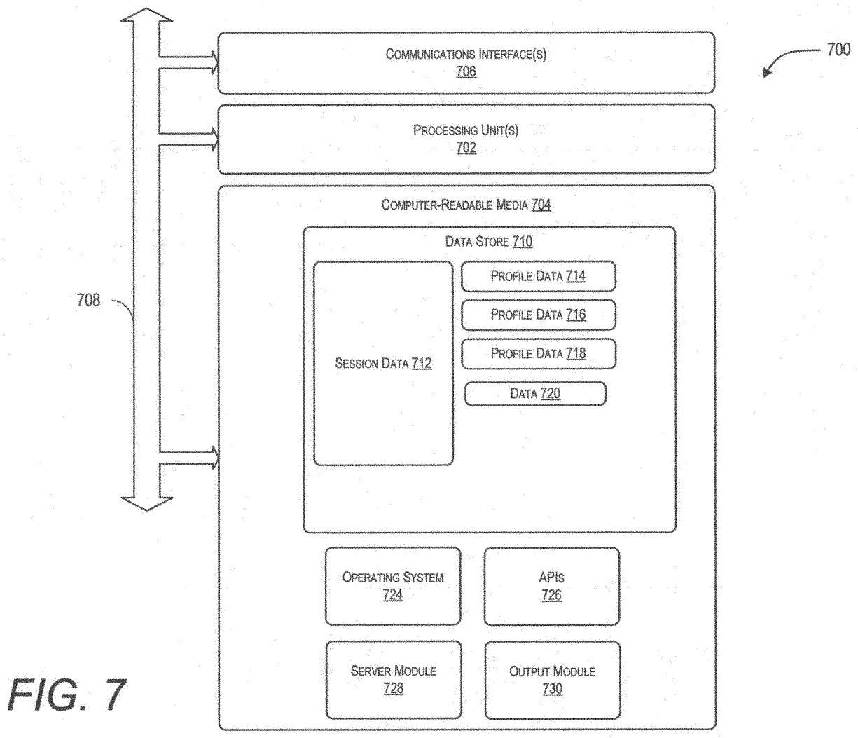

In FIG. 7, a system diagram of an example of an implementation of components of a device 700, such as a device of the one or more devices 642, is shown configured to receive requests from the computing device 602, send requests for data from the third-party entities 634, receiving data from the third-party entities 634, and sending the data to the computing device 602, respectively.

In this example, the device 700 includes one or more processing unit(s) 702, computer-readable media 704, and/or communication interface(s) 706. The components of the device 700 are in signal communication and operatively connected, for example, via a bus 708, which can include one or more of a system bus, a data bus, an address bus, a PCI bus, a Mini-PCI bus, and any variety of local, peripheral, and/or independent buses.

As utilized herein, the processing unit(s) may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized in this disclosure, a computer-readable media, such as computer-readable media 704 and/or computer-readable media 618, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network.

The computer-readable media 704 can include the data store 710. In some examples, the data store 610 includes data storage such as a database, data warehouse, or other type of structured or unstructured data storage. In some examples, the data store 610 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 710 can store data for the operations of processes, applications, components, and/or modules stored in computer-readable media 704 and/or executed by processing unit(s) 702 and/or accelerator(s). For instance, in some examples, the data store 710 can store session data 712 (between the computing device 602 and the third-party entity), profile data 714 for the computing device 602, profile data 716 for the third-party entity, profile data 718 for the third-party entities 634, requests, data 620 (such as, for example, first data 654, second data 658, and third data 666), and/or other data. The computer-readable media 704 can also include operating system 724 and APIs 726 configured to expose the functionality and the data of the device 700 to external devices associated with content server 600. Additionally, the computer-readable media 704 includes one or more server modules 728 and one or more output modules 730. In this example, the data store 710 may be part of the data store 650 shown in FIG. 6.

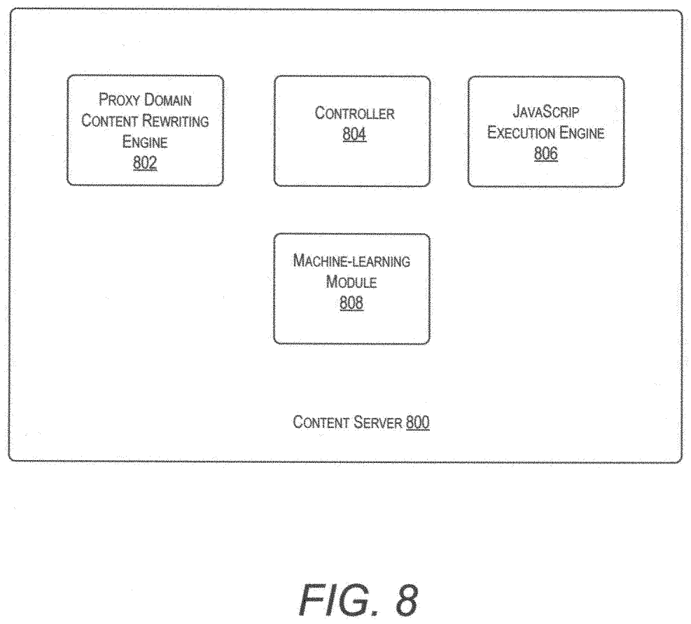

Turning to FIG. 8, a system block diagram of an example of another implementation of a content server 800 in accordance with the present disclosure. In this example, the content server 800 also includes one or more modules, such as a proxy domain content rewriting engine 802, a controller 804, a JavaScript execution engine 806, and a machine-learning module 808.

The JavaScript execution engine 806 performs some or all tasks of executing JavaScrpit rather than having them all performed by the computing device 602, thus reducing processing and content access time to improve the performance of the computing device 602 and corresponding experience of the enterprise-user 604. The JavaScript execution engine 806 may also simultaneously perform activities such as interactions with the third-party servers of the third-party entities 634. The machine learning module 808 may be used to reduce the risk of errors in content rewriting and to predict interactions with third-party entities 634 without the need to execute all scripts on the computing device 602. Additional similar modules could also be employed within the content server 800.

Again, the content server 800 is a proxy server that acts as an intermediary for requests from clients (i.e., the computing device 602) seeking resources from other servers (i.e., the third-party entity). Specifically, the content server 800 intercepts the request from the browser 636 and acts on behalf of the enterprise in a manner that may be transparent to the computing device 602, browser 636, and enterprise-user 604.

In this example, the proxy domain content rewriting engine 802 is a request/response processor and utilizes either the same domain as the original content or a special sub-domain for delivery of all advertising-related information. The proxy domain content rewriting engine 802 is resolved to the content server 800 to ensure privacy and security controls.

As an example, the content server 800 may replace all the links to the third-party entities 340 to point to a proxy domain and create a unique cookie/supercookie (“UC”) for tracking purposes. In this example, the content server 800 aliases the UC to all third-party trackers and the content server 800, where necessary, provides a JavaScript pass-through for third party domains but executes them on behalf of the third-party domains. The content server 800 can use a JavaScript execution module (such as JavaScript execution engine 806) to minimize the repeated execution of the same/similar automatically or manually defined script fragments for the given third-party entity.

In this example, the controller 804 is a cloud-based policy enforcement engine that can control the exchanges of information between the computing device 602 and the third-party entity. Per the content server 600 configuration by the enterprise and/or per the computing device 602 configuration, the controller 804 maintains and enforces tracking and data exchange policies. The controller 804 manages publisher-defined allow/block preferences for third-party trackers of the third-party entities 634. The controller 804 also manages end user-defined allow/block preferences for third-party trackers. For ease of the preference management of the enterprise-user 604, the controller 804 provides for default profiles typically derived from the enterprise preferences. In addition, the content server 800 implements various techniques for reducing latency and improving bandwidth utilization. For example, the content server 800 may implement compression technologies, transmission control protocol (“TCP”) optimization, caching, and the like.

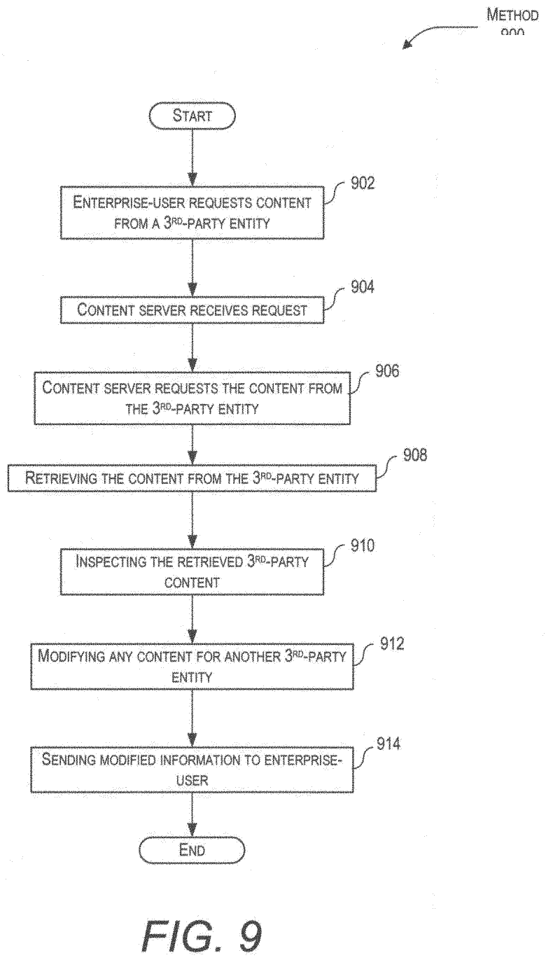

FIG. 9 is a flowchart of an example of an implementation of a method 900 of operation of the content server in accordance with the present disclosure. The method begins by the enterprise-user requesting 902 content from a third-party entity which is a specific public network site of the one or more public network sites and applications. The content server then receives 904, as an intermediary, a request from the computing device of the enterprise for information content from the specific public network site. The content server then requests 906 and accesses the information content from the specific public network site. The content server then receives 908, from the specific public network site, the information content within a first data. The content server then inspects 910 the received content and detects a link for external information within the first data, where the external information is located on an external server that is external to the specific public network site. The content server then requests the content from the external server, receives the external information from the external server, and modifies 912 the first data from the specific public network site with the external information to produce a modified information content and sending 914 the modified information content to the computing device. The method then ends.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Moreover, the operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A content server for establishing a virtual private network environment (“VPNE”) for application unification over a public network for an enterprise having a plurality of enterprise-users, wherein the public network has one or more public network sites and applications, the content server comprising:
one or more processing units;
a computer-readable media storing instructions that, when executed by the one or more processing units, cause the content server to perform operations comprising:
receiving, as an intermediary, a request from a computing device of the enterprise for information content from a specific public network site of the one or more public network sites and applications;
requesting the information content from the specific public network site;
receiving, from the specific public network site, the information content within a first data;
detecting a link for external information within the first data, wherein the external information is located on an external server that is external to the specific public network site;
receiving the external information from the external server;
modifying the first data from the specific public network site with the external information to produce a modified information content; and
sending the modified information content to the computing device.

2. The content server of claim 1, wherein the specific public network site is a third-party entity that is external to and independent of the enterprise.

3. The content server of claim 2, wherein the computing device is a server or enterprise-user of the enterprise.

4. The content server of claim 3, wherein the enterprise includes a regional office and the server is regional office server and the enterprise-user is a regional-office-user.

5. The content server of claim 3, wherein the enterprise-user is a remote-user.

6. The content server of claim 3, wherein the content server is associated with a gateway server located at a head-office of the enterprise.

7. The content server of claim 3,
wherein the computer-readable media stores login identification for the server or enterprise-user,
wherein the login identification corresponds to accounts established by the enterprise with the one or more public network sites for use by the server or enterprise-users, and
wherein requesting the information content from the third-party entity includes providing the third-party entity with the login identification for the corresponding server or enterprise-user.

8. The content server of claim 1, wherein requesting the information content from the specific public network site includes providing the specific public network site with modified input data from the computing device, wherein the modified input data is input data from the computing device that has been modified by the content server to prevent the specific public network from accessing sensitive personal or enterprise information from the input data provided by the computing device.

9. The content server of claim 8, wherein detecting the link for external content includes selectively preventing the redirection of data to an unapproved external server.

10. The content server of claim 9, wherein selectively preventing the redirection of data includes providing the unapproved external server with fake data.

11. The content server of claim 10, wherein an unapproved external server includes an external server located in an unapproved geolocation.

12. The content server of claim 1, wherein modifying the information content includes
stripping unapproved content from the external information to produce approved external information and
combining the approved external information with the first data to produce the modified information content.

13. A method for establishing a virtual private network environment (“VPNE”) for application unification over a public network for an enterprise having a plurality of enterprise-users utilizing a content server, wherein the public network has one or more public network sites and applications, the method comprising:
receiving, as an intermediary, a request from a computing device of the enterprise for information content from a specific public network site of the one or more public network sites and applications;
requesting, with the content server, the information content from the specific public network site;
receiving, from the specific public network site, at the content server the information content within a first data;
detecting a link for external information within the first data, wherein the external information is located on an external server that is external to the specific public network site;
receiving the external information from the external server at the content server;
modifying the first data from the specific public network site with the external information to produce a modified information content; and
sending the modified information content to the computing device.
